(19) United States
(12) Patent Application Publication
(10) Pub. No.: US 2020/0128238 A1
(43) Pub. Date: Apr. 23, 2020

(54) VIDEO SIGNAL PROCESSING METHOD AND DEVICE

(71) Applicant: KT CORPORATION, Gyeonggi-do (KR)

(72) Inventor: Bae Keun LEE, Seoul (KR)

(73) Assignee: KT CORPORATION, Gyeonggi-do (KR)

(21) Appl. No.: 16/472,857

(22) PCT Filed: Dec. 21, 2017
(86) PCT No.: PCT/KR2017/015281

§ 371 Date: Jun. 21, 2019

(30) Foreign Application Priority Data
Dec. 22, 2016 (KR) 10-2016-0176442
Dec. 22, 2016 (KR) 10-2016-0176443

(51) Int. Cl. H04N 19/105; H04N 19/132; H04N 19/46; H04N 19/137; H04N 19/513; H04N 19/159; H04N 19/176

(52) U.S. Cl. CPC H04N 19/105; H04N 19/132; H04N 19/46; H04N 19/176; H04N 19/513; H04N 19/159; H04N 19/137

(57) ABSTRACT

An image decoding method according to the present invention includes: obtaining motion information of a current block, specifying a reference block of the current block within a reference picture on the basis of the motion information, and generating a prediction block of the current block from the reference block.

### TECHNICAL FIELD

The present invention relates to a method and an apparatus for processing video signal.

### BACKGROUND ART

Recently, demands for high-resolution and high-quality images such as high definition (HD) images and ultra-high definition (UHD) images have increased in various application fields. However, higher resolution and quality image data has increasing amounts of data in comparison with conventional image data. Therefore, when transmitting image data by using a medium such as conventional wired and wireless broadband networks, or when storing image data by using a conventional storage medium, costs of transmitting and storing increase. In order to solve these problems occurring with an increase in resolution and quality of image data, high-efficiency image encoding/decoding techniques may be utilized.

Image compression technology includes various techniques, including: an inter-prediction technique of predicting a pixel value included in a current picture from a previous or subsequent picture of the current picture; an intra-prediction technique of predicting a pixel value included in a current picture by using pixel information in the current picture; an entropy encoding technique of assigning a short code to a value with a high appearance frequency and assigning a long code to a value with a low appearance frequency; etc. Image data may be effectively compressed by using such image compression technology, and may be transmitted or stored.

In the meantime, with demands for high-resolution images, demands for stereographic image content, which is a new image service, have also increased. A video compression technique for effectively providing stereographic image content with high resolution and ultra-high resolution is being discussed.

### DISCLOSURE

### Technical Problem

An objective of the present invention is to provide a method and apparatus for effectively encoding/decoding a 360-degree projection image when encoding/decoding a video signal.

Another objective of the present invention is to provide a method and apparatus for variably determining a motion compensation method of an encoding/decoding target block according to a position of a face including a reference block when encoding/decoding a video signal.

Still another objective of the present invention is to provide a method and apparatus for improving encoding/decoding efficiency by unifying at least one of sizes, shapes, and phases of a current face and a reference face when encoding/decoding a video signal.

Technical problems obtainable from the present invention are non-limited the above-mentioned technical task, and other unmentioned technical tasks can be clearly understood from the following description by those having ordinary skill in the technical field to which the present invention pertains.

### Technical Solution

A method and apparatus for decoding a video signal according to the present invention: obtains motion information of a current block, specifies a reference block of the current block within a reference picture on the basis of the motion information, and generates a prediction block of the current block from the reference block.

A method and apparatus for encoding a video signal according to the present invention performs motion compensation for a current block by using a reference block within a reference picture of a current block, and encodes motion information of the current block.

In the method and apparatus for encoding/decoding the video signal according to the present invention, the motion information may include information for specifying the reference face including the reference block.

In the method and apparatus for encoding/decoding the video signal according to the present invention, information for specifying the reference face may include flag information representing whether or not the reference face and the current face are identical.

In the method and apparatus for encoding/decoding the video signal according to the present invention, when the reference face and the current face are different, the information for specifying the reference face may further include index information for identifying the reference face among a plurality of faces included in the reference picture.

In the method and apparatus for encoding/decoding the video signal according to the present invention, the motion information includes a motion vector for specifying a position of the reference block within the reference face, and a start position of the motion vector is adaptively determined according to whether or not the current face and the reference face are identical.

In the method and apparatus for encoding/decoding the video signal according to the present invention, when the current face and the reference face are identical, the motion vector may represent a coordinate difference between a co-located block of the current block within the reference picture and the reference block.

In the method and apparatus for encoding/decoding the video signal according to the present invention, when the current face and the reference face are different, the motion vector may represent a coordinate difference between a reference position within the reference face and the reference block.

In the method and apparatus for encoding/decoding the video signal according to the present invention, when the current face and the reference face are different, motion compensation of the current block may be performed on the basis of a motion compensation reference face generated by converting the reference face to be matched with the current face.

The features briefly summarized above for the present invention are only illustrative aspects of the detailed description of the invention which are described below and do not limit the scope of the invention.

### Advantageous Effects

According to the present invention, a 360-degree projection image can be effectively encoded/decoded.

According to the present invention, a motion compensation method of an encoding/decoding target block can be variably determined according to a position of a face including a reference block.

According to the present invention, encoding/decoding efficiency can be improved by unifying at least one of sizes, shapes, and phases of a current face and a reference face.

Effects obtainable from the present invention may be non-limited by the above mentioned effect, and other unmentioned effects can be clearly understood from the following description by those having ordinary skill in the technical field to which the present invention pertains.

### DESCRIPTION OF DRAWINGS

FIG. 1 is a block diagram illustrating a device for encoding a video according to an embodiment of the present invention.

FIG. 2 is a block diagram illustrating a device for decoding a video according to an embodiment of the present invention.

FIG. 3 is a diagram illustrating partition modes that can be applied to a coding block when the coding block is encoded by inter prediction.

FIGS. 4 to 6 are views respectively showing an example of a camera apparatus for generating a panoramic image.

FIG. 7 is a view schematically showing encoding/decoding and rendering of a 360-degree video.

FIG. 8 is a view showing an equirectangular projection among 2D projection methods.

FIG. 9 is a view showing a cube map projection among 2D projection methods.

FIG. 10 is a view showing an icosahedral projection among 2D projection methods.

FIG. 11 is a view showing an octahedron projection among 2D projection methods.

FIG. 12 is a view showing a truncated pyramid projection among 2D projection methods.

FIG. 13 is a view showing an example of conversion between 2D face coordinates and 3D coordinates.

FIG. 14 shows an embodiment to which the present invention is applied, and is a view showing a flowchart of a method of performing inter prediction for a 2D image.

FIG. 15 is a view showing a process of deriving motion information of a current block when a merge mode is applied to the current block.

FIG. 16 is a view showing a process of deriving motion information of a current block when an AMVP mode is applied to the current block.

FIGS. 17A to 17C are views showing an example of a position of a reference block used for deriving a prediction block of a current block.

FIG. 18 is a view showing an example of identifying a face including a reference block by using a reference face index in a TPP-based 360-degree projection image.

FIG. 19 is a view showing a motion vector of a case where a current block and a reference block belong to the same face.

FIG. 20 is a view showing a motion vector of a case where a current block belongs to a face differing from a reference block.

FIG. 21 is a view showing an example of converting a reference face to be matched with a current face.

FIG. 22 is a view showing a method of performing inter prediction for a current block within a 360-degree projection image according to the present invention.

FIG. 23 is a view showing an example of generating a reference block on the basis of a sample belonging to a reference face.

FIG. 24 is a view showing an example of generating a motion compensation reference face by converting a second face adjacent to a first face in which a reference point of a reference block is included.

### MODE FOR INVENTION

A variety of modifications may be made to the present invention and there are various embodiments of the present invention, examples of which will now be provided with reference to drawings and described in detail. However, the present invention is not limited thereto, and the exemplary embodiments can be construed as including all modifications, equivalents, or substitutes in a technical concept and a technical scope of the present invention. The similar reference numerals refer to the similar element in described the drawings.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, preferred embodiments of the present invention will be described in detail with reference to the accompanying drawings. Hereinafter, the same constituent elements in the drawings are denoted by the same reference numerals, and a repeated description of the same elements will be omitted.

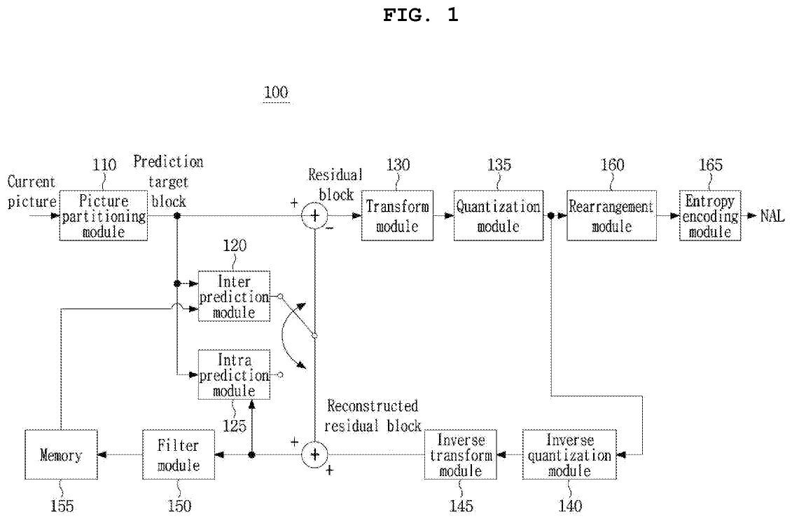

FIG. 1 is a block diagram illustrating a device for encoding a video according to an embodiment of the present invention.

Referring to FIG. 1, the device 100 for encoding a video may include: a picture partitioning module 110, prediction modules 120 and 125, a transform module 130, a quantization module 135, a rearrangement module 160, an entropy encoding module 165, an inverse quantization module 140, an inverse transform module 145, a filter module 150, and a memory 155.

The constitutional parts shown in FIG. 1 are independently shown so as to represent characteristic functions different from each other in the device for encoding a video. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

Also, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

The picture partitioning module 110 may partition an input picture into one or more processing units. Here, the processing unit may be a prediction unit (PU), a transform unit (TU), or a coding unit (CU). The picture partitioning module 110 may partition one picture into combinations of multiple coding units, prediction units, and transform units, and may encode a picture by selecting one combination of coding units, prediction units, and transform units with a predetermined criterion (e.g., cost function).

For example, one picture may be partitioned into multiple coding units. A recursive tree structure, such as a quad tree structure, may be used to partition a picture into coding units. A coding unit which is partitioned into other coding units with one picture or a largest coding unit as a root may be partitioned with child nodes corresponding to the number of partitioned coding units. A coding unit which is no longer partitioned by a predetermined limitation serves as a leaf node. That is, when it is assumed that only square partitioning is possible for one coding unit, one coding unit may be partitioned into four other coding units at most.

Hereinafter, in the embodiment of the present invention, the coding unit may mean a unit performing encoding, or a unit performing decoding.

A prediction unit may be one of partitions partitioned into a square or a rectangular shape having the same size in a single coding unit, or a prediction unit may be one of partitions partitioned so as to have a different shape/size in a single coding unit.

When a prediction unit subjected to intra prediction is generated based on a coding unit and the coding unit is not the smallest coding unit, intra prediction may be performed without partitioning the coding unit into multiple prediction units N×N.

The prediction modules 120 and 125 may include an inter prediction module 120 performing inter prediction and an intra prediction module 125 performing intra prediction. Whether to perform inter prediction or intra prediction for the prediction unit may be determined, and detailed information (e.g., an intra prediction mode, a motion vector, a reference picture, etc.) according to each prediction method may be determined. Here, the processing unit subjected to prediction may be different from the processing unit for which the prediction method and detailed content is determined. For example, the prediction method, the prediction mode, etc. may be determined by the prediction unit, and prediction may be performed by the transform unit. A residual value (residual block) between the generated prediction block and an original block may be input to the transform module 130. Also, prediction mode information, motion vector information, etc. used for prediction may be encoded with the residual value by the entropy encoding module 165 and may be transmitted to a device for decoding a video. When a particular encoding mode is used, it is possible to transmit to a device for decoding video by encoding the original block as it is without generating the prediction block through the prediction modules 120 and 125.

The inter prediction module 120 may predict the prediction unit based on information of at least one of a previous picture or a subsequent picture of the current picture, or may predict the prediction unit based on information of some encoded regions in the current picture, in some cases. The inter prediction module 120 may include a reference picture interpolation module, a motion prediction module, and a motion compensation module.

The reference picture interpolation module may receive reference picture information from the memory 155 and may generate pixel information of an integer pixel or less then the integer pixel from the reference picture. In the case of luma pixels, an 8-tap DCT-based interpolation filter having different filter coefficients may be used to generate pixel information of an integer pixel or less than an integer pixel in units of a ¼ pixel. In the case of chroma signals, a 4-tap DCT-based interpolation filter having different filter coefficient may be used to generate pixel information of an integer pixel or less than an integer pixel in units of a ⅛ pixel.

The motion prediction module may perform motion prediction based on the reference picture interpolated by the reference picture interpolation module. As methods for calculating a motion vector, various methods, such as a full search-based block matching algorithm (FBMA), a three step search (TSS), a new three-step search algorithm (NTS), etc., may be used. The motion vector may have a motion vector value in units of a ½ pixel or a ¼ pixel based on an interpolated pixel. The motion prediction module may predict a current prediction unit by changing the motion prediction method. As motion prediction methods, various methods, such as a skip method, a merge method, an AMVP (Advanced Motion Vector Prediction) method, an intra block copy method, etc., may be used.

The intra prediction module 125 may generate a prediction unit based on reference pixel information neighboring to a current block which is pixel information in the current picture. When the neighboring block of the current prediction unit is a block subjected to inter prediction and thus a reference pixel is a pixel subjected to inter prediction, the reference pixel included in the block subjected to inter prediction may be replaced with reference pixel information of a neighboring block subjected to intra prediction. That is, when a reference pixel is not available, at least one reference pixel of available reference pixels may be used instead of unavailable reference pixel information.

Prediction modes in intra prediction may include a directional prediction mode using reference pixel information depending on a prediction direction and a non-directional prediction mode not using directional information in performing prediction. A mode for predicting luma information may be different from a mode for predicting chroma information, and in order to predict the chroma information, intra prediction mode information used to predict luma information or predicted luma signal information may be utilized.

In performing intra prediction, when the size of the prediction unit is the same as the size of the transform unit, intra prediction may be performed on the prediction unit based on pixels positioned at the left, the top left, and the top of the prediction unit. However, in performing intra prediction, when the size of the prediction unit is different from the size of the transform unit, intra prediction may be performed using a reference pixel based on the transform unit. Also, intra prediction using N×N partitioning may be used for only the smallest coding unit.

In the intra prediction method, a prediction block may be generated after applying an AIS (Adaptive Intra Smoothing) filter to a reference pixel depending on the prediction modes. The type of the AIS filter applied to the reference pixel may vary. In order to perform the intra prediction method, an intra prediction mode of the current prediction unit may be predicted from the intra prediction mode of the prediction unit neighboring to the current prediction unit. In prediction of the prediction mode of the current prediction unit by using mode information predicted from the neighboring prediction unit, when the intra prediction mode of the current prediction unit is the same as the intra prediction mode of the neighboring prediction unit, information indicating that the prediction modes of the current prediction unit and the neighboring prediction unit are equal to each other may be transmitted using predetermined flag information. When the prediction mode of the current prediction unit is different from the prediction mode of the neighboring prediction unit, entropy encoding may be performed to encode prediction mode information of the current block.

Also, a residual block including information on a residual value which is a different between the prediction unit subjected to prediction and the original block of the prediction unit may be generated based on prediction units generated by the prediction modules 120 and 125. The generated residual block may be input to the transform module 130.

The transform module 130 may transform the residual block including the information on the residual value between the original block and the prediction unit generated by the prediction modules 120 and 125 by using a transform method, such as discrete cosine transform (DCT), discrete sine transform (DST), and KLT. Whether to apply DCT, DST, or KLT in order to transform the residual block may be determined based on intra prediction mode information of the prediction unit used to generate the residual block.

The quantization module 135 may quantize values transformed to a frequency domain by the transform module 130. Quantization coefficients may vary depending on the block or importance of a picture. The values calculated by the quantization module 135 may be provided to the inverse quantization module 140 and the rearrangement module 160.

The rearrangement module 160 may rearrange coefficients of quantized residual values.

The rearrangement module 160 may change a coefficient in the form of a two-dimensional block into a coefficient in the form of a one-dimensional vector through a coefficient scanning method. For example, the rearrangement module 160 may scan from a DC coefficient to a coefficient in a high frequency domain using a zigzag scanning method so as to change the coefficients to be in the form of one-dimensional vectors. Depending on the size of the transform unit and the intra prediction mode, vertical direction scanning where coefficients in the form of two-dimensional blocks are scanned in the column direction or horizontal direction scanning where coefficients in the form of two-dimensional blocks are scanned in the row direction may be used instead of zigzag scanning. That is, which scanning method among zigzag scanning, vertical direction scanning, and horizontal direction scanning is used may be determined depending on the size of the transform unit and the intra prediction mode.

The entropy encoding module 165 may perform entropy encoding based on the values calculated by the rearrangement module 160. Entropy encoding may use various encoding methods, for example, exponential Golomb coding, context-adaptive variable length coding (CAVLC), and context-adaptive binary arithmetic coding (CABAC).

The entropy encoding module 165 may encode a variety of information, such as residual value coefficient information and block type information of the coding unit, prediction mode information, partition unit information, prediction unit information, transform unit information, motion vector information, reference frame information, block interpolation information, filtering information, etc. from the rearrangement module 160 and the prediction modules 120 and 125.

The entropy encoding module 165 may entropy encode the coefficients of the coding unit input from the rearrangement module 160.

The inverse quantization module 140 may inversely quantize the values quantized by the quantization module 135 and the inverse transform module 145 may inversely transform the values transformed by the transform module 130. The residual value generated by the inverse quantization module 140 and the inverse transform module 145 may be combined with the prediction unit predicted by a motion estimation module, a motion compensation module, and the intra prediction module of the prediction modules 120 and 125 such that a reconstructed block can be generated.

The filter module 150 may include at least one of a deblocking filter, an offset correction unit, and an adaptive loop filter (ALF).

The deblocking filter may remove block distortion that occurs due to boundaries between the blocks in the reconstructed picture. In order to determine whether to perform deblocking, the pixels included in several rows or columns in the block may be a basis of determining whether to apply the deblocking filter to the current block. When the deblocking filter is applied to the block, a strong filter or a weak filter may be applied depending on required deblocking filtering strength. Also, in applying the deblocking filter, horizontal direction filtering and vertical direction filtering may be processed in parallel.

The offset correction module may correct offset with the original picture in units of a pixel in the picture subjected to deblocking. In order to perform the offset correction on a particular picture, it is possible to use a method of applying offset in consideration of edge information of each pixel or a method of partitioning pixels of a picture into the predetermined number of regions, determining a region to be subjected to perform offset, and applying the offset to the determined region.

Adaptive loop filtering (ALF) may be performed based on the value obtained by comparing the filtered reconstructed picture and the original picture. The pixels included in the picture may be divided into predetermined groups, a filter to be applied to each of the groups may be determined, and filtering may be individually performed for each group. Information on whether to apply ALF and a luma signal may be transmitted by coding units (CU). The shape and filter coefficient of a filter for ALF may vary depending on each block. Also, the filter for ALF in the same shape (fixed shape) may be applied regardless of characteristics of the application target block.

The memory 155 may store the reconstructed block or picture calculated through the filter module 150. The stored reconstructed block or picture may be provided to the prediction modules 120 and 125 in performing inter prediction.

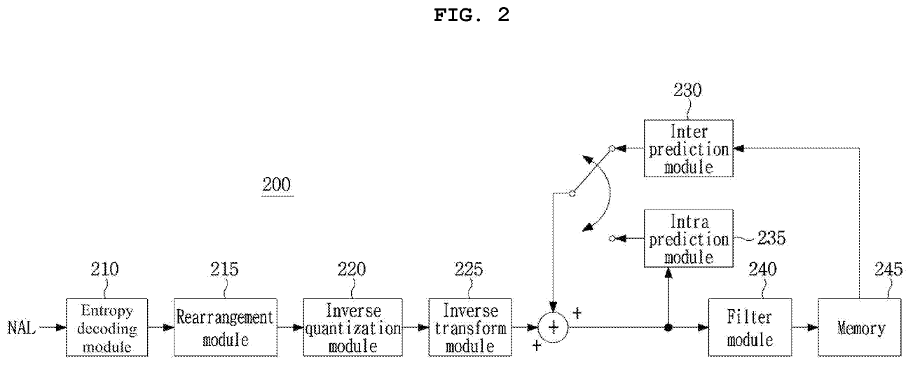

FIG. 2 is a block diagram illustrating a device for decoding a video according to an embodiment of the present invention.

Referring to FIG. 2, the device 200 for decoding a video may include: an entropy decoding module 210, a rearrangement module 215, an inverse quantization module 220, an inverse transform module 225, prediction modules 230 and 235, a filter module 240, and a memory 245.

When a video bitstream is input from the device for encoding a video, the input bitstream may be decoded according to an inverse process of the device for encoding a video.

The entropy decoding module 210 may perform entropy decoding according to an inverse process of entropy encoding by the entropy encoding module of the device for encoding a video. For example, corresponding to the methods performed by the device for encoding a video, various methods, such as exponential Golomb coding, context-adaptive variable length coding (CAVLC), and context-adaptive binary arithmetic coding (CABAC) may be applied.

The entropy decoding module 210 may decode information on intra prediction and inter prediction performed by the device for encoding a video.

The rearrangement module 215 may perform rearrangement on the bitstream entropy decoded by the entropy decoding module 210 based on the rearrangement method used in the device for encoding a video. The rearrangement module may reconstruct and rearrange the coefficients in the form of one-dimensional vectors to the coefficient in the form of two-dimensional blocks. The rearrangement module 215 may receive information related to coefficient scanning performed in the device for encoding a video and may perform rearrangement via a method of inversely scanning the coefficients based on the scanning order performed in the device for encoding a video.

The inverse quantization module 220 may perform inverse quantization based on a quantization parameter received from the device for encoding a video and the rearranged coefficients of the block.

The inverse transform module 225 may perform the inverse transform, i.e., inverse DCT, inverse DST, and inverse KLT, which is the inverse process of transform, i.e., DCT, DST, and KLT, performed by the transform module on the quantization result by the device for encoding a video. Inverse transform may be performed based on a transfer unit determined by the device for encoding a video. The inverse transform module 225 of the device for decoding a video may selectively perform transform schemes (e.g., DCT, DST, and KLT) depending on multiple pieces of information, such as the prediction method, the size of the current block, the prediction direction, etc.

The prediction modules 230 and 235 may generate a prediction block based on information on prediction block generation received from the entropy decoding module 210 and previously decoded block or picture information received from the memory 245.

As described above, like the operation of the device for encoding a video, in performing intra prediction, when the size of the prediction unit is the same as the size of the transform unit, intra prediction may be performed on the prediction unit based on the pixels positioned at the left, the top left, and the top of the prediction unit. In performing intra prediction, when the size of the prediction unit is different from the size of the transform unit, intra prediction may be performed using a reference pixel based on the transform unit. Also, intra prediction using N×N partitioning may be used for only the smallest coding unit.

The prediction modules 230 and 235 may include a prediction unit determination module, an inter prediction module, and an intra prediction module. The prediction unit determination module may receive a variety of information, such as prediction unit information, prediction mode information of an intra prediction method, information on motion prediction of an inter prediction method, etc. from the entropy decoding module 210, may divide a current coding unit into prediction units, and may determine whether inter prediction or intra prediction is performed on the prediction unit. By using information required in inter prediction of the current prediction unit received from the device for encoding a video, the inter prediction module 230 may perform inter prediction on the current prediction unit based on information of at least one of a previous picture or a subsequent picture of the current picture including the current prediction unit. Alternatively, inter prediction may be performed based on information of some pre-reconstructed regions in the current picture including the current prediction unit.

In order to perform inter prediction, it may be determined for the coding unit which of a skip mode, a merge mode, an AMVP mode, and an inter block copy mode is used as the motion prediction method of the prediction unit included in the coding unit.

The intra prediction module 235 may generate a prediction block based on pixel information in the current picture. When the prediction unit is a prediction unit subjected to intra prediction, intra prediction may be performed based on intra prediction mode information of the prediction unit received from the device for encoding a video. The intra prediction module 235 may include an adaptive intra smoothing (AIS) filter, a reference pixel interpolation module, and a DC filter. The AIS filter performs filtering on the reference pixel of the current block, and whether to apply the filter may be determined depending on the prediction mode of the current prediction unit. AIS filtering may be performed on the reference pixel of the current block by using the prediction mode of the prediction unit and AIS filter information received from the device for encoding a video. When the prediction mode of the current block is a mode where AIS filtering is not performed, the AIS filter may not be applied.

When the prediction mode of the prediction unit is a prediction mode in which intra prediction is performed based on the pixel value obtained by interpolating the reference pixel, the reference pixel interpolation module may interpolate the reference pixel to generate the reference pixel of an integer pixel or less than an integer pixel. When the prediction mode of the current prediction unit is a prediction mode in which a prediction block is generated without interpolation the reference pixel, the reference pixel may not be interpolated. The DC filter may generate a prediction block through filtering when the prediction mode of the current block is a DC mode.

The reconstructed block or picture may be provided to the filter module 240. The filter module 240 may include the deblocking filter, the offset correction module, and the ALF.

Information on whether or not the deblocking filter is applied to the corresponding block or picture and information on which of a strong filter and a weak filter is applied when the deblocking filter is applied may be received from the device for encoding a video. The deblocking filter of the device for decoding a video may receive information on the deblocking filter from the device for encoding a video, and may perform deblocking filtering on the corresponding block.

The offset correction module may perform offset correction on the reconstructed picture based on the type of offset correction and offset value information applied to a picture in performing encoding.

The ALF may be applied to the coding unit based on information on whether to apply the ALF, ALF coefficient information, etc. received from the device for encoding a video. The ALF information may be provided as being included in a particular parameter set.

The memory 245 may store the reconstructed picture or block for use as a reference picture or block, and may provide the reconstructed picture to an output module.

As described above, in the embodiment of the present invention, for convenience of explanation, the coding unit is used as a term representing a unit for encoding, but the coding unit may serve as a unit performing decoding as well as encoding.

In addition, a current block may represent a target block to be encoded/decoded. And, the current block may represent a coding tree block (or a coding tree unit), a coding block (or a coding unit), a transform block (or a transform unit), a prediction block (or a prediction unit), or the like depending on an encoding/decoding step. In this specification, ‘unit’ represents a basic unit for performing a specific encoding/decoding processes, and ‘block’ may represent a sample array of a predetermined size. If there is no distinguish between them, the terms ‘block’ and ‘unit’ may be used interchangeably. For example, in the embodiments described below, it can be understood that a coding block and a coding unit have mutually equivalent meanings.

A picture may be encoded/decoded by divided into base blocks having a square shape or a non-square shape. At this time, the base block may be referred to as a coding tree unit. The coding tree unit may be defined as a coding unit of the largest size allowed within a sequence or a slice. Information regarding whether the coding tree unit has a square shape or has a non-square shape or information regarding a size of the coding tree unit may be signaled through a sequence parameter set, a picture parameter set, or a slice header. The coding tree unit may be divided into smaller size partitions. At this time, if it is assumed that a depth of a partition generated by dividing the coding tree unit is 1, a depth of a partition generated by dividing the partition having depth 1 may be defined as 2. That is, a partition generated by dividing a partition having a depth k in the coding tree unit may be defined as having a depth k+1.

A partition of arbitrary size generated by dividing a coding tree unit may be defined as a coding unit. The coding unit may be recursively divided or divided into base units for performing prediction, quantization, transform, or in-loop filtering, and the like. For example, a partition of arbitrary size generated by dividing the coding unit may be defined as a coding unit, or may be defined as a transform unit or a prediction unit, which is a base unit for performing prediction, quantization, transform or in-loop filtering and the like.

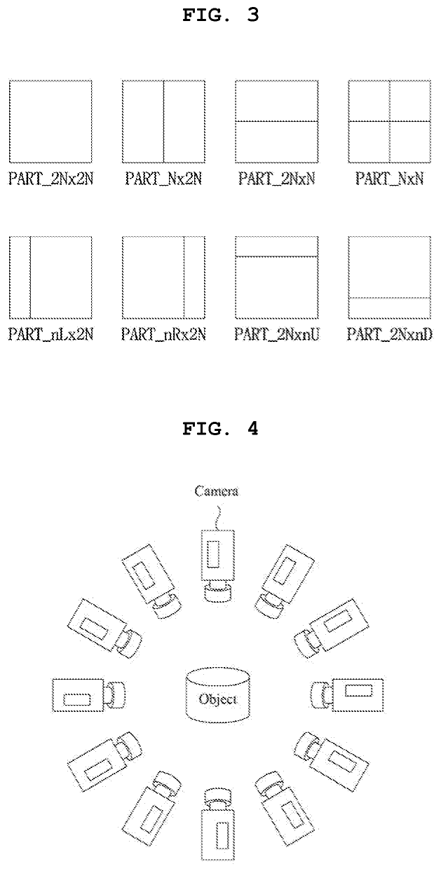

Alternatively, if a coding block is determined, a prediction block having the same size as the coding block or smaller than the coding block may be determined through predictive partitioning of the coding block. The predictive partitioning of the coding block may be performed by a partition mode (Part_mode) indicating a partition type of the coding block. A size or a shape of a prediction block may be determined according to the partition mode of the coding block. The partition type of the coding block may be determined through information specifying any one of partition candidates. At this time, depending on a size, a shape, an encoding mode or the like of the coding block, the partition candidates available to the coding block may include an asymmetric partition type (for example, nL×2N, nR×2N, 2N×nU, 2N×nD). For example, the partition candidates available to the coding block may be determined according to the encoding mode of the current block. For example, FIG. 3 illustrates partition modes that can be applied to a coding block when the coding block is encoded by inter prediction.

When a coding block is encoded by inter prediction, one of 8 partition modes can be applied to the coding block, as in the example shown in FIG. 3.

On the other hand, when a coding block is encoded by intra prediction, a partition mode of PART_2N×2N or PART_N×N can be applied to the coding block.

PART_N×N may be applied when a coding block has a minimum size. Here, the minimum size of the coding block may be predefined in the encoder and the decoder. Alternatively, information regarding the minimum size of the coding block may be signaled via the bitstream. For example, the minimum size of the coding block is signaled through a slice header, so that the minimum size of the coding block may be defined for each slice.

In another example, partition candidates available to a coding block may be determined differently depending on at least one of a size or a shape of the coding block. For example, the number or a type of partition candidates available to a coding block may be differently determined according to at least one of a size or a shape of the coding block.

Alternatively, a type or the number of asymmetric partition candidates among partition candidates available to a coding block may be limited depending on a size or a shape of the coding block. For example, the number or a type of asymmetric partition candidates available to a coding block may be differently determined according to at least one of a size or a shape of the coding block.

In general, a prediction block may have a size from 64×64 to 4×4. However, when a coding block is encoded by inter prediction, it is possible to prevent the prediction block from having a 4×4 size in order to reduce a memory bandwidth when performing motion compensation.

A field of view of video captured by a camera is limited depending on the angle of view of the camera. In order to overcome the above problem, images are captured by using a plurality of cameras, and a single video or bitstream may be configured by performing stitching for the captured images. In an example, FIGS. 4 to 6 respectively show an example of capturing up and down, left to right, and front and back at the same time by using a plurality of cameras. As above, a video generated by performing stitching for a plurality of videos may be referred to as a panoramic video. Particularly, an image having a degree of freedom of 360-degree based on a predetermined central axis may be referred to as a 360-degree video.

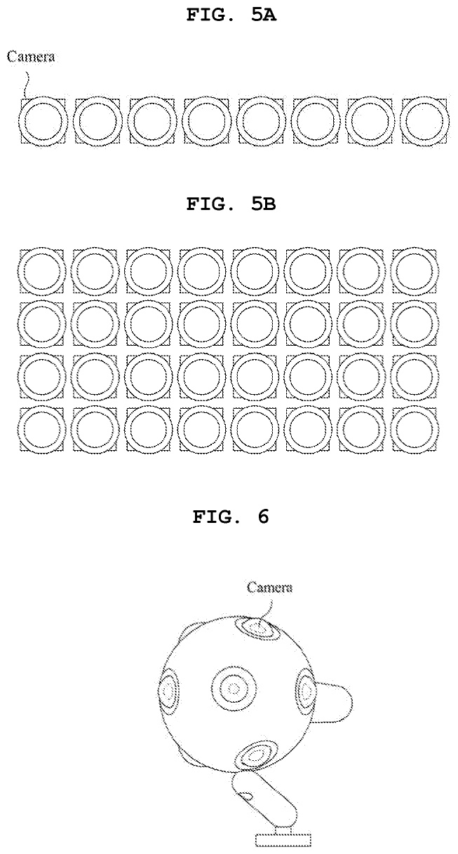

A camera structure (or a camera arrangement) for obtaining a 360-degree video may be a circular array as shown in an example shown in FIG. 4, an one-dimensional vertical/horizontal array as shown in an example shown in FIG. 5A, or a two-dimensional array as shown in an example shown in FIG. 5B (that is, a form where a vertical array and a horizontal array are combined). Alternatively, as shown in an example shown in FIG. 6, a plurality of cameras may be arranged on a sphere-form device.

An example described below will be described on the basis of a 360-degree video. However, applying the example described below to a panoramic video rather than a 360-degree video will be also included in the technical scope of the present invention.

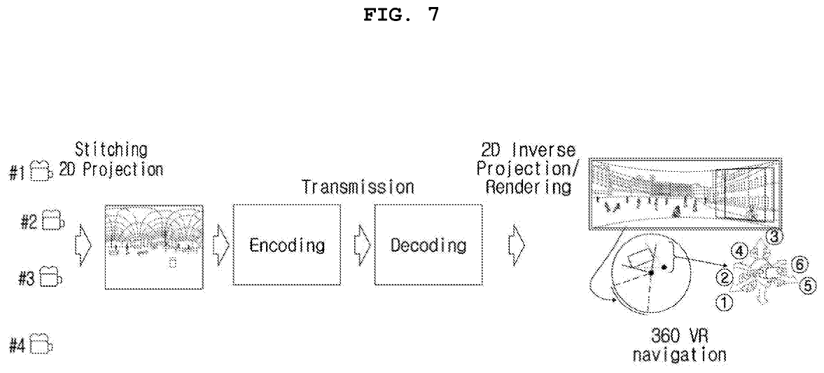

FIG. 7 is a view schematically showing encoding/decoding and rendering of a 360-degree video.

In order to encode/decode a 360-degree video by using the encoder/decoder of FIG. 1/FIG. 2, a 360-degree video has to be converted into a video of a 2D form. In other words, after converting image information of a three-dimensional space into a form of 2D by a projection (2D projection), encoding/decoding for the converted image may be performed. By performing an inverse projection for a 2D image that has been already encoded/decoded, an image having a degree of freedom of 360 degree in the up and down, left and right, or front and rear directions may be provided.

When converting a 360-degree video into a 2D projection, various methods may be used such as an equirectangular projection (ERP), a cube map projection (CMP), an icosahedral projection (ISP), an octahedron projection (OHP), a truncated pyramid projection (TPP), a sphere segment projection (SSP), a rotated sphere projection (RSP), etc.

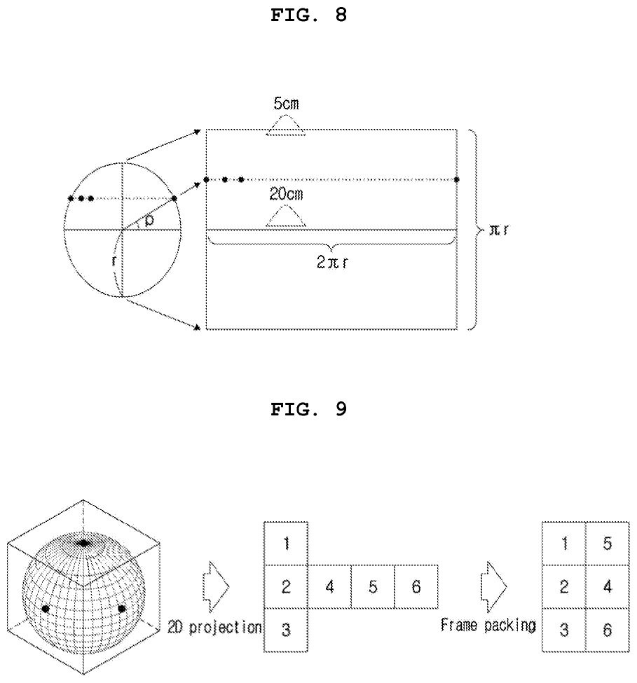

FIG. 8 is a view showing an equirectangular projection among 2D projection methods.

The equirectangular projection is a method of performing projection for pixels on sphere to a rectangle of a 2:1 ratio, and is a 2D projection method that is widely used. When using the equirectangular projection, an actual length of a sphere corresponding to a unit length on a 2D plane becomes shorter toward the pole of the sphere. For example, coordinates between both ends of the unit length on the 2D plane corresponds to 20 cm at a nearby equator of the sphere, but the same corresponds to 5 cm at a nearby pole of the sphere. Accordingly, encoding efficiency degrades in the equirectangular projection since image distortion becomes large close to the pole of the sphere.

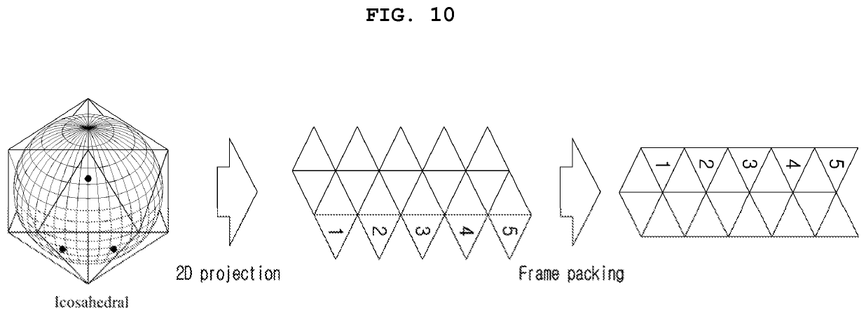

FIG. 9 is a view showing a cube map projection method among 2D projection methods.

The cube map projection is a method of approximating 3D data to a cube form, and then performing a 2D projection for the cube. When projecting 3D data to a cube, one face (or plane) may be configured to be in contact with four faces. Encoding efficiency is better in the cube map projection than the equirectangular projection since continuity between respective faces is high. After converting 3D data by using 2D projection, encoding/decoding may be performed by rearranging the 2D projection images in a rectangle form. Rearranging the 2D projection images in a rectangle form may be referred to as frame rearrangement or frame packing.

FIG. 10 is a view showing an icosahedral projection among 2D projection methods.

The icosahedral projection is a method of approximating 3D data to an icosahedral, and performing a 2D projection for the same. The icosahedral projection has advantage in continuity between faces. In addition, frame packing that performs rearrangement for 2D projection images may be performed.

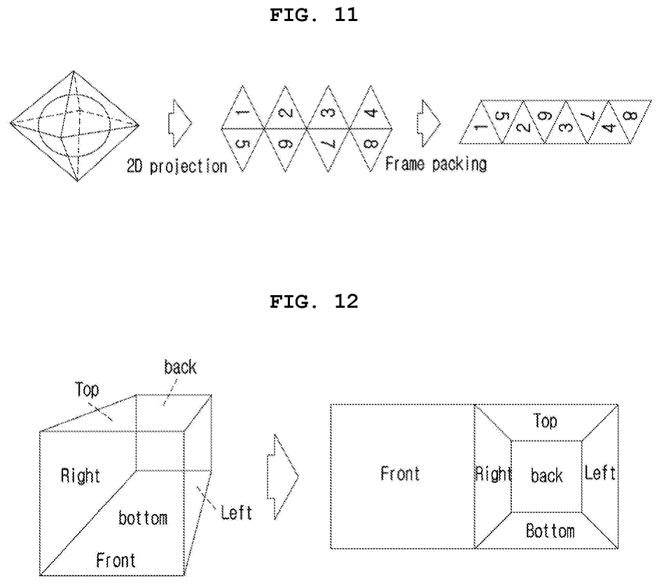

FIG. 11 is a view showing an octahedron projection among 2D projection methods.

The octahedron projection is a method of approximating 3D data to a regular octahedron, and performing a 2D projection for the same. The octahedron projection has advantage in continuity between faces. In addition, frame packing that performs rearrangement for 2D projection images may be performed.

FIG. 12 is a view showing a truncated pyramid projection among 2D projection methods.

The truncated pyramid projection is a method of approximating 3D data to be associated with a truncated pyramid, and performing a 2D projection for the same. In the truncated pyramid projection, frame packing may be performed so that a face of a specific view has a size differing from a neighboring face. For example, as an example shown in FIG. 12, a front face may have a size greater than a lateral face and a back face. When using the truncated pyramid projection, encoding/decoding efficiency at a specific view is better than another view since image data at the specific view is large.

The SSP is a method of divinizing a sphere into a high latitude area, a low latitude area, and an intermediate latitude area, mapping two high latitude areas of the north and south to two circles, and mapping the intermediate latitude area to a square as ERP.

The RSP represents a method of mapping a sphere to a form of two ellipses like a tennis ball.

Hereinafter, in an example described below, a 2D image generated by using a 2D projection is referred to as a 360-degree projection image. In addition, in an example described below, even though the example is described on the basis of a specific projection method, the example described below may be applied to a projection method other than the described projection method.

Each sample of a 360-degree projection image may be identified in 2D face coordinates. 2D face coordinates may include an index f for identifying a face on which a sample is positioned, and coordinates (m, n) representing a sample grid in a 360-degree projection image.

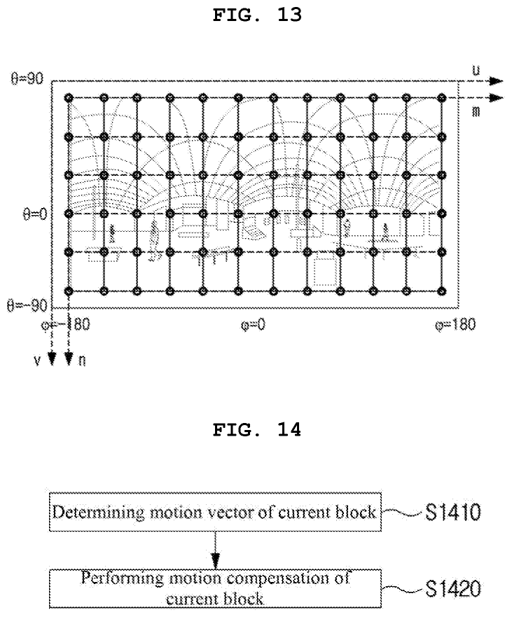

A 2D projection and image rendering may be performed through conversion between 2D face coordinates and 3D coordinates. In an example, FIG. 13 is a view showing an example of conversion between 2D face coordinates and 3D coordinates. When a 360-degree projection image is generated on the basis of ERP, conversion between 3D coordinates (x, y, z) and 2D face coordinates (f, m, n) may be performed by using Equations 1 to 4 below.

ϕ=tan⁻¹(−Z/X)

θ=sin⁻¹(Y/(X²+Y²+Z²)^{1/2}) [Equation 1]

ϕ=(u−0.5)*(2*π)

θ=(0.5−v)*π [Equation 2]
u=(m+0.5)/W,0≤m<W

v=(n+0.5)/H,0≤n<H [Equation 3]

u=(m+0.5)/W,0≤m<W

v=(n+0.5)/H,0≤n<H [Equation 4]

In a 360-degree projection image, a current picture may include at least one face. Herein, a number of faces may be a natural number of 1, 2, 3, 4 or more depending on a projection method. f of 2D face coordinates may be set to a value equal to or smaller than a number of faces. The current picture may include at least one face of the same picture order count (POC).

Alternatively, a number of faces constituting a current picture may be fixed or variable. For example, a number of faces constituting a current picture may be limited not to exceed a predetermined threshold value. Herein, the threshold value may be a value predefined in the encoder and the decoder. Alternatively, information of a maximum number of faces constituting a single picture may be signaled through a bitstream.

Faces may be determined by dividing a current picture by using at least one direction of a horizontal line, a vertical line, or a diagonal line according to a projection method.

For each face within a picture, an index may be assigned so as to identify each face. Parallel processing may be available to faces as in a case of tiles or slices. Accordingly, when performing intra prediction or inter prediction for a current block, an adjacent block belonging to a face different from the current block may be determined as unavailable.

Faces for which parallel processing is not available (or non-parallel processing area) may be defined, or faces with interdependencies may be defined. For example, faces for which parallel processing is not available or faces with interdependencies may be sequentially encoded/decoded rather than being encoded/decoded in parallel. Accordingly, a neighboring block included in a face different from a current block may be determined to be available for intra prediction or inter prediction of the current block according to whether or not parallel processing is available between faces or according to a dependency between faces.

In a 360-degree projection image, inter prediction may be performed on the basis of motion information of a current block as like in encoding/decoding of a 2D image. In an example, FIGS. 14 to 16 are views respectively showing a flowchart of a method of performing inter prediction for a 2D image.

FIG. 14 shows an embodiment to which the present invention is applied, and is a view showing a flowchart of a method of performing inter prediction for a 2D image.

Referring to FIG. 14, motion information of a current block may be determined S1410. Motion information of the current block may include at least one of a motion vector of the current block, a reference picture index of the current block, and an inter prediction direction of the current block.

Motion information of the current block may be obtained on the basis of at least one of information signaled through a bitstream, and motion information of a neighboring block adjacent to the current block.

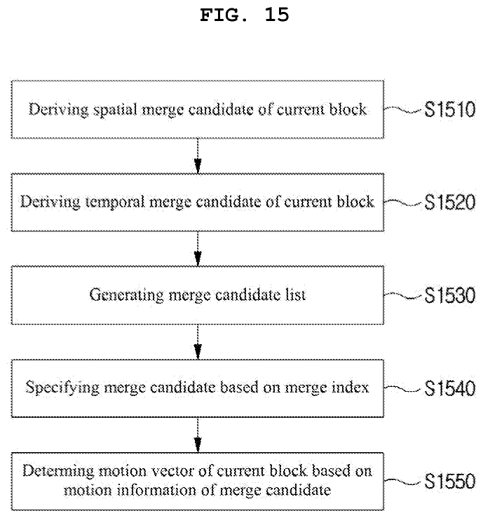

FIG. 15 is a view showing a process of deriving motion information of a current block when a merge mode is applied to the current block.

When a merge mode is applied to a current block, a spatial merge candidate may be derived from a block spatially adjacent to the current block S1510. The spatial neighboring block may include a block adjacent to at least one of top, left, and corner (e.g., at least one of top-left corner, right-top corner, and left-bottom corner) of the current block.

Motion information of a spatial merge candidate may be set to be identical to motion information of a spatial neighboring block.

A temporal merge candidate may be derived from a temporal neighboring block of the current block S1520. The temporal neighboring block may mean a co-located block included in a co-located picture. The co-located picture has a POC differing from a current picture including the current block. The co-located picture may be determined as a picture having a predefined index in a reference picture list, or may be determined by an index signaled through a bitstream. The temporal neighboring block may be determined as an arbitrary block within a block having the same position and size with the current block in the co-located picture block, or a block adjacent to the block having the same position and size with the current block. In an example, at least one of a block including central coordinates of a block having the same position and size with the current block in the co-located picture, or a block adjacent to a right-bottom boundary of the above block may be determined as a temporal neighboring block.

Motion information of the temporal merge candidate may be determined on the basis of motion information of the temporal neighboring block. In an example, a motion vector of the temporal merge candidate may be determined on the basis of a motion vector of the temporal neighboring block. In addition, an inter prediction direction of the temporal merge candidate may be set to be identical to an inter prediction direction of the temporal neighboring block. However, a reference picture index of the temporal merge candidate may have a fixed value. In an example, a reference picture index of the temporal merge candidate may be set to “0”.

Subsequently, a merge candidate list including the spatial merge candidate and the temporal merge candidate may be generated S1530. When a number of merge candidates included in the merge candidate list is smaller than a maximum number of merge candidates, a combined merge candidate obtained by combining at least two merge candidates or a merge candidate having a motion vector of (0,0) (zero motion vector) may be included in the merge candidate list.

When the merge candidate list is generated, at least one of merge candidates included in the merge candidate list may be specified on the basis of a merge candidate index S1540.

Motion information of the current block may be set to be identical to motion information of the merge candidate specified by the merge candidate index S1550. In an example, when a spatial merge candidate is selected by the merge candidate index, motion information of the current block may be set to be identical to motion information of a spatial neighboring block. Alternatively, when a temporal merge candidate is selected by the merge candidate index, motion information of the current block may be set to be identical to motion information of a temporal neighboring block.

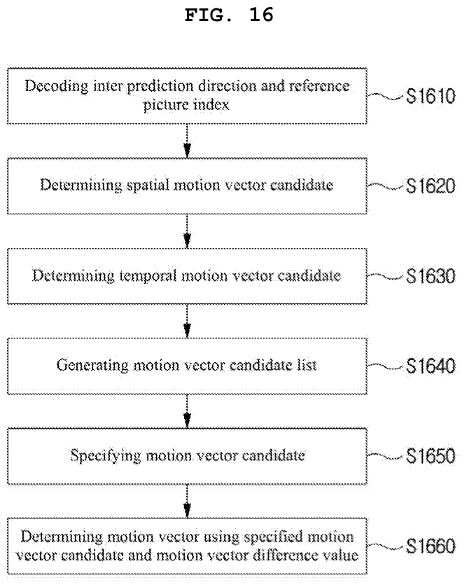

FIG. 16 is a view showing a process of deriving motion information of a current block when an AMVP mode is applied to the current block.

When an AMVP mode is applied to a current block, at least one of an inter prediction direction of the current block, or a reference picture index may be decoded from a bitstream S1610. In other words, when an AMVP mode is applied, at least one of an inter prediction direction of the current block, or a reference picture index may be determined on the basis of information encoded through a bitstream.

A spatial motion vector candidate may be determined on the basis of a motion vector of a spatial neighboring block of the current block. The spatial motion vector candidate may include at least one of a first spatial motion vector candidate derived from a top neighboring block of the current block, and a second spatial motion vector candidate derived from a left neighboring block of the current block. Herein, the top neighboring block may include at least one of blocks adjacent to a top or top-right corner of the current block, and the left neighboring block of the current block may include at least one of blocks adjacent to a left or left-bottom corner of the current block. The block adjacent to a left-top corner of the current block may be used as an top neighboring block or may be used as a left neighboring block.

When reference pictures of between the current block and the spatial neighboring block are different, a spatial motion vector may be obtained by performing scaling for a motion vector of the spatial neighboring block.

A temporal motion vector candidate may be determined on the basis of a motion vector of the temporal neighboring block of the current block S1630. When reference pictures of between the current block and the temporal neighboring block are different, a temporal motion vector may be obtained by performing scaling for a motion vector of the temporal neighboring block.

A motion vector candidate list including the spatial motion vector candidate and the temporal motion vector candidate may be generated S1640.

When the motion vector candidate list is generated, at least one of motion vector candidates included in the motion vector candidate list may be specified on the basis of information specifying at least one from the motion vector candidate list S1650.

The motion vector candidate specified by the information may be set as a motion vector prediction value of the current block, and a motion vector of the current block may be obtained by adding a motion vector difference value to the motion vector prediction value S1660. Herein, the motion vector difference value may be parsed through a bitstream.

When the motion information of the current block is obtained, motion compensation of the current block may be performed on the basis of the obtained motion information S1420. In detail, motion compensation of the current block may be performed on the basis of the inter prediction direction of the current block, the reference picture index, and the motion vector.

As described with reference to FIGS. 14 to 16, inter prediction for a 360-degree projection image may be performed in a block unit and on the basis of motion information of a current block. For example, when performing inter prediction for a 360-degree projection image, a prediction block of a current encoding/decoding block in a current picture may be derived from an area that is most similar to the prediction block in a reference picture. Herein, a reference block in a reference picture which is used for deriving the prediction block of the current block may be positioned on a face identical or different from the current block.

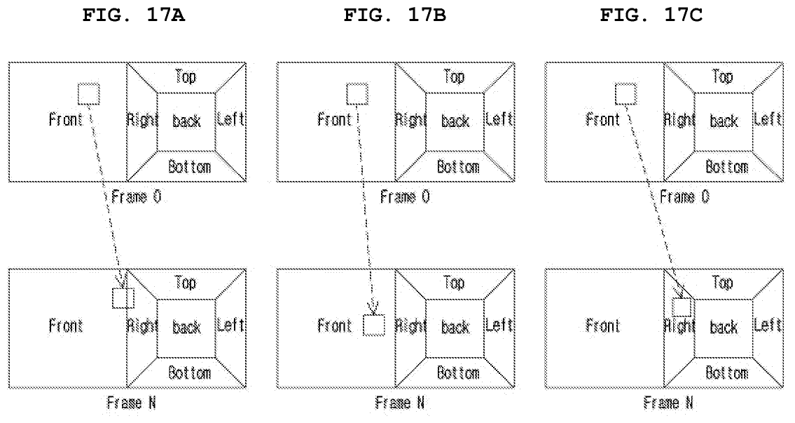

FIGS. 17A to 17C are views showing an example of a position of a reference block used for deriving a prediction block of a current block.

As in an example shown in FIGS. 17A to 17C, a reference block in a reference picture which is used for deriving a prediction block of a current block may be present on a face identical to the current block in a current picture (refer to 17B), or may be present on a face differing from the current block in the current picture (refer to 17C). Alternatively, a reference block may be present or spanned on at least two faces (refer to 17A).

A reference picture including a reference block may be a picture having a POC differing from the current picture.

Alternatively, a current picture may be used as a reference picture. For example, a block that is encoded/decoded previous than a current block in a current picture including the current block may be set as a reference block of the current block.

As shown in the example, a prediction block of a current block may be derived from a reference block included in a face identical to the current block or from a reference block included in a face differing from the current block. Herein, a position of the reference block may be specified through a motion vector between a co-located block corresponding to the current block in the reference picture and the reference block.

In another example, in order to reduce data amount required for encoding/decoding a motion vector, motion compensation for a current block may be performed by using at least one of information for specifying a face including a reference block, and/or a motion vector specifying a position of a reference block in the corresponding face. A face including a reference block within a reference picture may be referred to as a “reference face”.

Information for specifying a face including a reference block may include at least one of information representing whether or not a reference block belongs to a face identical to a current block, and/or information for identifying a face including a reference block (e.g., reference face index). For example, whether or not a reference block belongs to a face identical to a current block may be determined by using a 1-bit flag. In addition, a face including a reference block in a reference picture may be specified by using a reference face index.

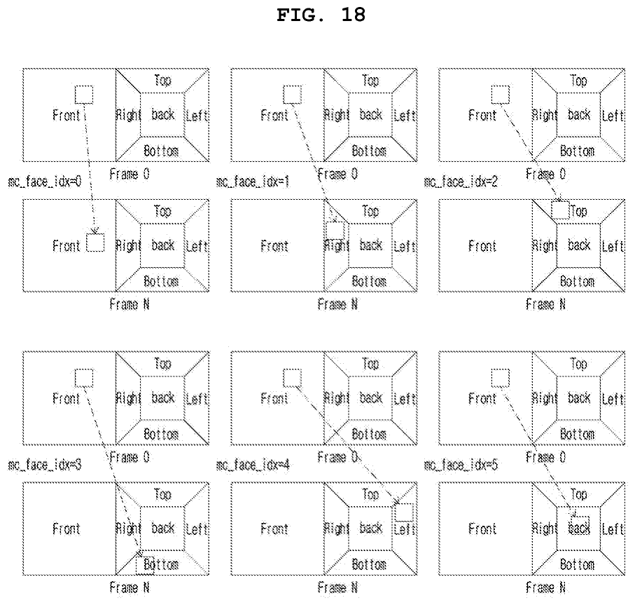

FIG. 18 is a view showing an example of identifying a face including a reference block by using a reference face index in a TPP-based 360-degree projection image.

As an example shown in FIG. 18, a reference face index “mc_face_idx” (or, “ref_face_idx”) for identifying a face including a reference block may be defined. A reference face index may be encoded/decoded through a bitstream.

In another example, a reference face index may be derived from a block adjacent to a current block. For example, in a merge mode, a reference face index of a current block may be derived from a merge candidate that is merged to the current block. However, in an AMVP mode, a face index of a current block may be encoded/decoded through a bitstream.

When a reference block is present in boundaries of two faces, a reference face index may specify a face including a reference position of the reference block. Herein, the reference position may include a position of a specific corner of the reference block (example.g., top-left sample) or a central point of the reference block.

A position of a reference block in the face may be specified on the basis of a vector value from a reference position of a reference face to a reference position of the reference block. Herein, the reference position of the reference face may be a position of a specific corner of the face (example.g., position of a top left reference sample), or a central point of the face.

Alternatively, a reference position of a reference face may be variable determined according to an index of a face including a current block (i.e., current face index), a reference face index, a relative position between a current face and the reference face, or a position of the current block in the face. For example, when a current block is present at a first position in a first face, a second position corresponding to the first position in a reference face may be determined as a reference position. In another example, when a current face is positioned at the left of a reference face, a reference position of the reference face may be set to a top-left corner, and when a current face is positioned at the top of a reference face, a reference position of the reference face may be set to the top center. A motion vector from a reference position of a face to a reference block may be referred to as a face vector.

Whether or not a motion vector is a face vector may be determined on the basis of whether or not a current face and a reference face are identical (i.e., whether or not a current face index and a reference face index are identical). For example, when a current face index and a reference face index are identical, a motion vector may indicate a vector from a current block to a reference block. However, when a current face index and a reference face index are different, a motion vector may indicate a vector from a reference position of a reference face to a reference block.

Alternatively, information representing whether or not a motion vector is a face vector may be encoded/decoded through a bitstream.

A motion vector of a current block (for example, face vector or non-face vector) may be encoded/decoded through a bitstream. For example, a motion vector value may be encoded/decoded as it is through a bitstream.

Alternatively, according to an inter prediction mode of a current block, a motion vector may be encoded/decoded through a bitstream, or a motion vector of a current block may be derived from a neighboring block. For example, when an inter prediction mode of a current block is an AMVP mode, a motion vector of the current block may be encoded/decoded by differential coding. Herein, the differential coding represents encoding/decoding a difference between a motion vector of a current block and a motion vector prediction value through a bitstream. The motion vector prediction value may be derived from a spatial/temporal neighboring block of the current block. Alternatively, a motion vector of a current block may be identically derived with a spatial/temporal neighboring block of the current block. However, when an inter prediction mode of a current block is a merge mode, a motion vector of the current block may be set to be identical to a motion vector of a spatial/temporal neighboring block of the current block.

When a motion vector of a current block differs in type from a neighboring block, a motion vector of the current block may be derived by matching a motion vector of a neighboring block to a motion vector type of the current block. For example, when a motion vector of a current block is a non-face vector, but a motion vector of a neighboring block is a face vector, the face vector of the neighboring block may be converted into a non-face vector by using a vector between the neighboring block and a reference point of a reference face of the neighboring block, and the face vector of the neighboring block. A motion vector of a current block may be derived on the basis of the converted non-face vector of the neighboring block according to an inter prediction mode of the current block.

In another example, a method of encoding/decoding a motion vector of a current block may be variably determined according to whether or not a motion vector of a current block is a face vector or a non-face vector. For example, when a motion vector of a current block is a non-face vector, the motion vector of the current block may be derived by using a motion vector of a neighboring block, but when the motion vector of the current block is a face vector, a face vector value may be encoded/decoded as it is through a bitstream.

As described above with reference to the example, in a 360-degree projection image, motion compensation of a current block may be performed through a reference block belonging to a face differing from a current block. However, when a face including a current block differs in at least one of a phase, a size, and a shape with a face including a reference block, it is difficult to find a reference block that is matched with a prediction block of the current block in a reference face. For example, in TPP, since a front face differs in a size and a shape with a right face, a block included in the front face and a block included the right face are hardly have similarity. Accordingly, when motion estimation or motion compensation is performed by using a reference face having a phase, a size, and a shape differing from the current face, a conversion for matching a phase, a size, and a shape of the reference face and the current face may be necessary.

Hereinafter, a method of performing inter prediction according to whether or not a current block and a reference block belong to the same face (or whether or not a current block and a reference block belong to mutual corresponding faces) will be described.

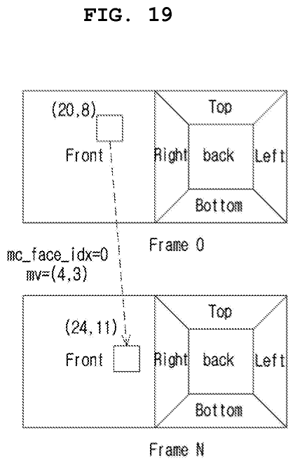

FIG. 19 is a view showing a motion vector of a case where a current block and a reference block belong to the same face.

When a current block and a reference block are included in the same face (i.e., when a current face index and a reference face index are identical), a coordinate difference between a starting point of the current block and a starting point of the reference block may be used as a motion vector as like in a 2D image.

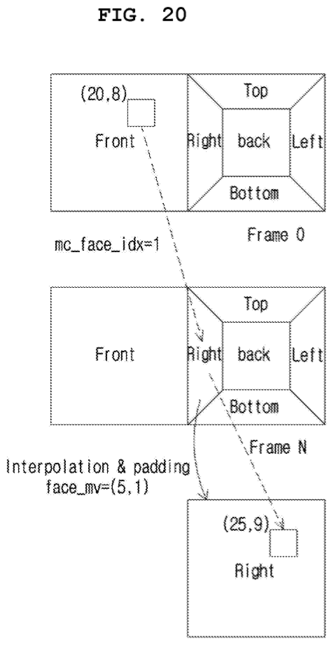

FIG. 20 is a view showing a motion vector of a case where a current block belongs to a face differing from a reference block.

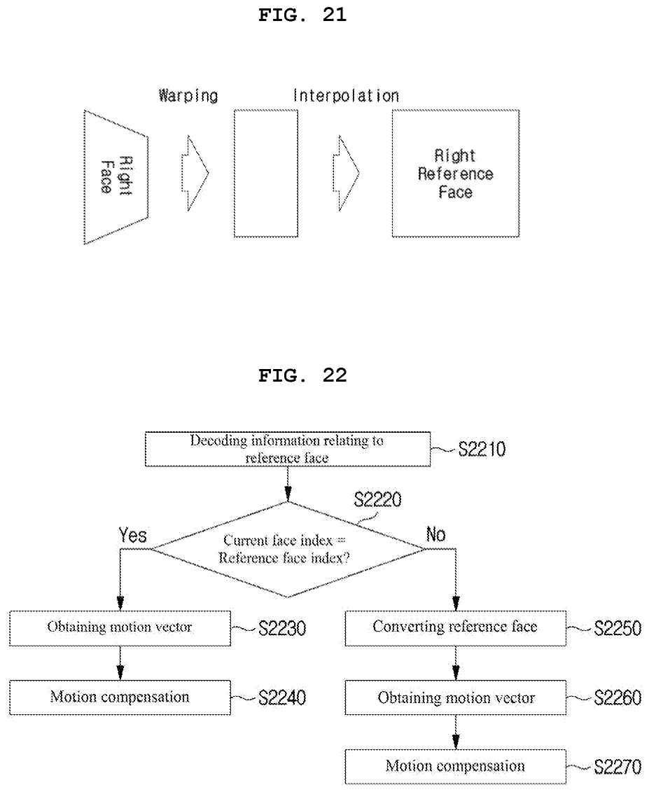

When a current block belongs to a face differing from a reference block (i.e., a current face index and a reference face index are different), and a current face differs in at least one of a size, a shape, or a phase from a reference face, a face including the reference block may be converted to be matched with a size, a shape or a phase of a face to which the prediction block belongs. For example, a reference face may be converted by using at least one of a phase conversion (warping), interpolation and/or padding. In an example, FIG. 21 is a view showing an example of converting a reference face to be matched with a current face. When a current face differs in a size and/or a shape from a reference face, as an example shown in FIG. 21, the reference face may be converted to have the same size and/or shape with the current face by applying a phase conversion, padding or interpolation to the reference face. When converting the reference face, at least one of a phase conversion, padding, and/or interpolation may be skipped, and converting the reference face may be performed in an order differing from the example shown in FIG. 21.

The reference face that is converted to be matched with the current face may be referred to as a motion compensation reference face (or reference face for motion compensation).

A motion compensation reference face may be interpolated in a predefined precision (e.g., quarter-pel or integer-pel, etc.). A block that is mostly close to a prediction block of a current block in the interpolated motion compensation reference face may be generated as the prediction block of the current block. As an example shown in FIG. 20, a motion vector of a current block may represent a coordinate difference between a start position of the current block and a start position of a reference block (i.e., encoding/decoding a non-face vector). Although it is not shown, a coordinate difference between a reference position in a motion compensation reference face and a start position of a reference block may be set as a motion vector of a current block (i.e., encoding/decoding a face vector).

FIGS. 20 and 21 show examples of converting a reference face to be matched with a phase, a size, or a shape of a current face. Contrary to what are shown, a motion vector of a current block may be derived by converting a current face to be matched with a phase, a size, or a shape of a reference face.

As in the above example, when a current face differs in at least one of a phase, a size, or a shape from a reference face, inter prediction may be performed by converting at least one of a phase, a size, or a shape of the current face or the reference face.

FIG. 22 is a view showing a method of performing inter prediction for a current block in a 360-degree projection image according to the present invention.

Referring to FIG. 22, information related to a reference face may be decoded from a bitstream S2210. When information related to a reference face is decoded, whether or not a current block and a reference block belong to the same face may be determined on the basis of the decoded information S2220.

Information related to a reference face may include at least one of whether or not a current block and a reference block belong to the same face, or a reference face index.

For example, “isSameFaceFlag” representing whether or not a face in which a current block is included and a face in which a reference block is included correspond to each other, or whether or not a current face index and a reference face index are identical may be signaled through a bitstream. When a value of isSameFaceFlag is 1, it may mean that a current face index and a reference face index have the same value, or a face in which a current block is included and a face in which a reference block is included correspond to each other. However, when a value of isSameFaceFlag is 0, it may mean that a current face and a reference face index have different values, or a face in which a current block is included and a face in which a reference block is included do not correspond to each other.

A reference face index may be signaled in a case where a value of isSameFaceFlag is 0. Alternatively, signaling isSameFaceFlag may be omitted, and a reference face index may be signaled essentially. When signaling isSameFaceFlag is omitted, whether or not a current block and a reference block belong to the same face may be determined by comparing a current face index and a reference face index.

When it is determined that a current block and a reference block are included in the same face, a motion vector representing a coordinate difference between positions of the current block and the reference block in the reference face may be obtained S2230, and motion compensation may be performed by using the obtained motion vector S2240.

On the other hands, when it is determined that a current block and a reference block are included in different faces, a motion compensation reference face may be generated by converting at least one of a phase, a size, or a shape of a reference face to be matched with a current face S2250. When a motion vector reference face is generated, a motion vector representing a coordinate difference between the current block and a reference block in the motion compensation reference face may be obtained, and motion compensation may be performed by using the obtained motion vector.

Even though the current block and the reference block belong to different faces, generating a motion vector reference face may be omitted when at least one of a phase, a size, or a shape of the current face and the reference face is identical.

In another example, whether or not to convert a reference face may be determined on the basis of whether or not a reference block belongs to a specific face. For example, in a TPP-based 360-degree projection image, a flag representing whether or not a reference block is present on a front face may be signaled. isRefInFrontFlag represents whether or not a reference block is present on a front face, and when a value thereof is 1, it may represent that a start point of the reference block is present on the front face, and when a value thereof is 0, it may mean that the start point of the reference block is present at a right, left, top, bottom or back face. When both a current block and a reference block belong to a front face, or when both a current block and a reference block do not belong to a front face, generating a motion compensation reference face may be omitted. Meanwhile, when one of a current block and a reference block belongs to a front face and the other does not belong to the front face, a motion compensation reference face may be generated, and a reference block in the generated motion compensation reference face may be specified.

In a 360-degree projection image, it is also possible to set to perform motion compensation of a current block by using only a reference block belonging to a face identical to the current block. Motion estimation and motion compensation of a current block may be performed for a reference block belonging to a face identical to the current block. For example, as in an example shown in FIG. 17C, motion compensation in a case of when a current block and a reference block belong to different faces may not be allowed. A face in which a reference block is included may be determined on the basis of a position of a reference point of the reference block. Herein, the reference point of the reference block may be a corner sample or a center point of the reference block. For example, even though a reference block is spanned in boundaries of two faces, when a reference point of the reference block belongs to a face identical to a current face, it may be determined that the reference block belongs to a face identical to the current block.

Whether or not to perform motion compensation by using a reference block belonging to a face differing from the current block may be adaptively determined on the basis of a projection method, a face size/shape, or a size difference between faces. Alternatively, information (e.g., flag) representing whether it is allowed to use a reference block belonging to a face differing from a current block for performing motion compensation may be signaled through a bitstream.

Motion compensation of a current block may be performed on the basis of a reference block generated by performing interpolation, padding, or phase conversion for a pixel belonging to a reference face corresponding to a current face. For example, when a reference block is spanned in at least two faces, and a reference point of the reference block belongs to a reference face corresponding to a current face, the reference block may include a first area belonging to a reference face corresponding to a current face (hereinafter, referred as a first face), and a second area belonging to a reference face beside the current face (hereinafter, referred as a second face).

Herein, a pixel of the second area may be generated by performing padding or interpolation for a sample included in the first face, or a pixel of the second area may be generated by applying a predetermined filter to at least one of a pixel included in the first face, and/or a pixel of the second face. The predetermined filter may mean a weight filter, an average filter or an interpolation filter. A pixel area to which a filter is applied may be the entire or a partial area of the first face and/or second face. Herein, the partial area may be the first area and the second area, or may be an area having a size/shape predetermined in the encoder/decoder. The filter may be applied to at least one pixel adjacent to boundaries of the first face and the second face.

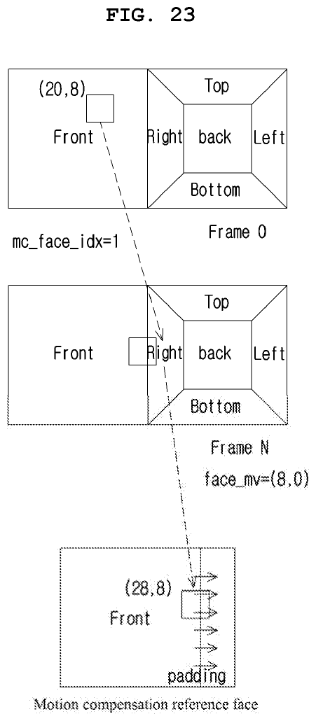

FIG. 23 is a view showing an example of generating a reference block on the basis of a sample belonging to a reference face.

As an example shown in FIG. 23, motion compensation of a current block may be performed on the basis of a reference block generated by performing padding and/or interpolation for a sample included in a boundary of a reference face (first face) corresponding to a current face, or by applying a filter to a sample included in a first face and a sample included in a second face adjacent to the first face.

In an example shown in FIG. 23, a padding area is generated by performing padding for a sample included in a front face to which a reference point of a reference block belongs, and motion compensation of a current block is performed by using a sample included in the padding area.

Alternatively, a motion compensation reference face is generated by performing a phase conversion for the entire or partial area of a second face by using a value of a first face, and motion compensation of a current block may be performed by using the generated motion compensation reference face.

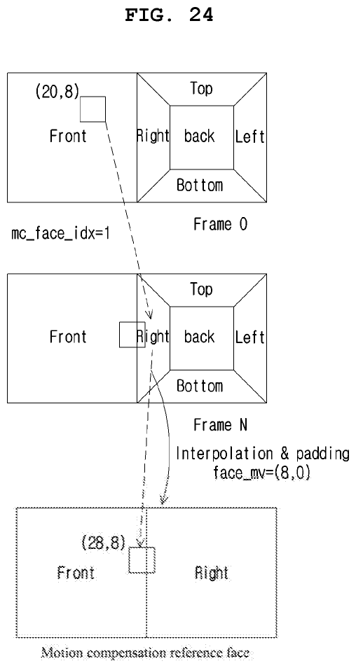

FIG. 24 is a view showing an example of generating a motion compensation reference face by converting a second face adjacent to a first face in which a reference point of a reference block is included.

As an example shown in FIG. 24, a motion compensation reference face may be generated by performing at least one of a conversion, interpolation, and padding for the entire or partial area of a second face that includes a partial area of a reference block but does not include a reference point of the reference block. Accordingly, motion compensation of a current block may be performed by using a sample belonging to the motion compensation reference face.

Information representing whether or not a reference block generated on the basis of a value of a sample belonging to a reference face corresponding to a current face is used for motion compensation may be encoded/decoded through a bitstream. The information is a 1-bit flag. For example, when a flag value is 0, it may mean that a reference block generated on the basis of a value of a sample belonging to a reference face corresponding to a current face is not used for motion compensation, and when a flag value is 1, it may mean that a reference block generated on the basis of a value of a sample belonging to a reference face corresponding to a current face may be used for motion compensation of a current block.

Faces may differ in a size/shape according to a projection method of 3D data. For example, in a TPP projection method, a front face may be greater than other faces. A face with a small size has an information amount relatively smaller than a face with a large size. Accordingly, encoding efficiency may be improved by increasing a precision of a motion vector in a face with a small size. In other words, a precision of a motion vector may be adaptively determined according to a size/shape of a reference face including a reference block.

For example, in a TPP-based 360-degree projection image, when a reference block belongs to a front face, motion compensation may be performed by using a quarter pel (¼ pel), and when a reference block belongs to a right face, a left face, an top face, or a bottom face which is smaller than the front face, motion compensation may be performed by using an octo pel (⅛ pel).

On the other hands, when a size of a reference face becomes large, a small motion vector precision may be used, and when a size of a reference face becomes small, a large motion vector precision may be used.

In the above example, a picture configured with a plurality of faces may be used as a reference picture. In another example, each face may be used as a reference picture, or a group of a predetermined number of faces may be used as a reference picture. Alternatively, in a TPP-based 360-degree projection image, a front face may be used as a reference picture, or in addition to using the front face as the reference picture, at the same time, a group of other faces may be used as the reference picture.

Although the above-described embodiments have been described on the basis of a series of steps or flowcharts, they are not intended to limit the inventive time-series order, and may be performed simultaneously or in a different order. In addition, each of the components (for example, units, modules, etc.) constituting the block diagram in the above-described embodiment may be implemented as a hardware device or software, and a plurality of components may be combined into one hardware device or software. The above-described embodiments may be implemented in the form of program instructions that may be executed through various computer components and recorded in a computer-readable recording medium. The computer-readable storage medium may include a program instruction, a data file, a data structure, and the like either alone or in combination thereof. Examples of the computer-readable storage medium include magnetic recording media such as hard disks, floppy disks and magnetic tapes; optical data storage media such as CD-ROMs or DVD-ROMs; magneto-optical media such as floptical disks; and hardware devices, such as read-only memory (ROM), random-access memory (RAM), and flash memory, which are particularly structured to store and implement the program instruction. The hardware devices may be configured to be operated by one or more software modules or vice versa to conduct the processes according to the present invention.

### INDUSTRIAL APPLICABILITY

The present invention may be applied to an electronic device capable of encoding/decoding an image.

1. A method of decoding an image, the method comprising:
obtaining motion information of a current block;
specifying a reference block of the current block within a reference picture on the basis of the motion information; and
generating a prediction block of the current block from the reference block,
wherein the reference block is generated by performing interpolation, padding, or conversion for a sample included in a first face in association with a current face including the current block within the reference picture.

2. The method of claim 1, wherein the motion information includes information for specifying a reference face including the reference block.

3. The method of claim 2, wherein the information for specifying the reference face includes flag information representing whether or not the reference face and the current face are identical.

4. The method of claim 3, wherein when the reference face and the current face are different, the information for specifying the reference face further includes index information for identifying the reference face among a plurality of faces included in the reference picture.

5. The method of claim 3, wherein the motion information includes a motion vector for specifying a position of the reference block within the reference face, and a start position of the motion vector is adaptively determined according to whether or not the current face and the reference face are identical.

6. The method of claim 5, wherein when the current face and the reference face are identical, the motion vector represents a coordinate difference between a co-located block of the current block within the reference picture and the reference block.

7. The method of claim 5, wherein when the current face and the reference face are different, the motion vector represents a coordinate difference between a reference position within the reference face and the reference block.

8. The method of claim 1, wherein when the current face and the reference face are different, motion compensation of the current block is performed on the basis of a motion compensation reference face generated by converting the reference face to be matched with the current face.

9. A method of encoding an image, the method comprising:
performing motion compensation for a current block by using a reference block within a reference picture of a current block; and
encoding motion information of the current block,
wherein the reference block is generated by performing interpolation, padding, or conversion for a sample included in a first face in association with a current face including the current block within the reference picture.

10. The method of claim 9, wherein the motion information includes information for specifying a reference face including the reference block.

11. The method of claim 10, wherein the information for specifying the reference face includes flag information representing whether or not the reference face and the current face are identical.

12. The method of claim 11, wherein when the reference face and the current face are different, the information for specifying the reference face further includes index information for identifying the reference face among a plurality of faces included in the reference picture.

13. The method of claim 10, wherein the motion information includes a motion vector for specifying a position of the reference block within the reference face, and a starting position of the motion vector is adaptively determined according to whether or not the current face and the reference face are identical.

14. The method of claim 9, wherein when the current face and the reference face are different, motion compensation of the current block is performed on the basis of a motion compensation reference face generated by converting the reference face to be matched with the current face.

15. An apparatus for decoding an image, the apparatus comprising:
an inter prediction unit obtaining motion information of a current block, specifying a reference block of the current block within a reference picture on the basis of the motion information, and generating a prediction block of the current block from the reference block, wherein
the reference block is generated by performing interpolation, padding, or conversion for a sample included in a first face in association with a current face including the current block within the reference picture.
